(19) United States
(12) Patent Application Publication
(10) Pub. No.: US 2004/0036821 A1
(43) Pub. Date: Feb. 26, 2004

(54) Liquid crystal shutter

(75) Inventors: Michael V. Paukshto, Foster City, CA (US); Louis D. Silverstein, Scottsdale, AZ (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(73) Assignee: OPTIVA, INC.

(21) Appl. No.: 10/394,556

(22) Filed: Mar. 21, 2003

Related U.S. Application Data
(60) Provisional application No. 60/405,581, filed on Aug. 22, 2002.

(51) Int. Cl. G02F 1/1347

(52) U.S. Cl. 349/74

(57) ABSTRACT

A liquid crystal shutter is provided comprising at least two liquid crystal cells and at least three polarizers. Each of the liquid crystal cells contains a plurality of layers between two substrates and is disposed between two adjacent polarizers. The adjacent two liquid crystal cells have substantially equal absolute values and opposite directions of twist angles. The liquid crystal shutter of the invention substantially increases the viewing angle and the contrast ratio at large viewing angles, provides a symmetrical dependence of the contrast ratio on the viewing angle, and decreases the switching time as well as the driving voltages. The shutter provides substantially improved angular characteristics, high contrast ratio, good transparency in the light state, and a fast switching time.

### RELATED APPLICATION

This application claims priority to the U.S. Provisional Patent Application No. ______, filed Dec. 11, 2002, the disclosure of which is hereby incorporated by reference.

### FIELD OF THE INVENTION

This invention relates to liquid crystal devices and in particular to eye protective devices based on liquid crystal optical cells using twist effects. These devices can be used in welding goggles or helmets with auto-darkening filters designed for work with sources of bright irradiation in visible, ultraviolet, and infrared regions. These devices may also be used in other eye protective devices, stereoscopic eyeglasses, liquid crystal display (LCD) projectors of high brightness, and to replace mechanical shutters in cameras and other optical apparatuses.

### BACKGROUND OF THE INVENTION

A technical problem, which is solved in this invention, is to create a liquid crystal display shutter with an electrically driven darkening property having a high darkening degree (a contrast ratio) in a broad range of viewing angles. From the technical standpoint, the proposed display device is an electrically driven device for modulating light intensity.

The main idea, distinguishing the autodarkening protective glass from a usual dark glass in the welding goggle or helmet, is a possibility to automatically switch on the protective filter upon ignition of the arc. This provides a more reliable eye protection for a welder and makes his work more convenient. In order for such a device to afford effective eye protection for a welder, it is also of critical importance that the filter be switched on very rapidly after ignition of the welding arc.

In the technical field associated with devices protecting eyes against bright electromagnetic irradiation, it is commonplace to characterize the darkening ability by DIN darkening units. A darkening degree of an optical filter with optical transmission T measured in fractions of unity is calculated in DIN units as:

$$D = 1 + \frac{7}{3} {log}_{10} ( \frac{1}{T} ) \qquad ( 1 )$$

As a liquid crystal shutter may have two states, dark and light, it is necessary, for a complete description, to define the darkening degree D₁ and the transmission T₁ for a dark state and the darkening degree D₂ and the transmission T₂ for a light state. The shutter contrast,

$$k = \frac{{T}_{2}}{{T}_{1}} \qquad ( 2 )$$

frequently used in the LCD technology, can be linked with its darkening degrees by the following simple formula:

$${log}_{10} ( k ) = \frac{3}{7} ( {D}_{1} - {D}_{2} ) \qquad ( 3 )$$

Standard requirements imposed upon these devices are as follows:

A high darkening degree in the on-state is no less than 10 DIN units. The electrical arc used for welding has very high brightness; therefore, a welder's eyes and face need protection provided by a sufficiently dark glass absorbing the main part of the arc irradiation.

A sufficiently low darkening degree in the off-state is no greater than 4-5 Din units. It is evident that the protective glass should be transparent in the absence of the arc to provide clear vision.

A rapid response time for switching-on and switching-off is less than 0.1 second. Upon ignition of the welding arc, the shutter should rapidly switch to a dark state to provide protection of a welder's eyes, as well as to avoid temporary blinding caused by a bright flash. Here, the maximal admissible switching time is 0.1 second but smaller switching times are preferable.

A sufficient viewing area and a sufficient viewing angle are necessary to provide convenient working vision as well as reliable protection of a welder's eyes when viewing a welding job at oblique angles. Moreover, the shutter should ensure protection against side patches of light produced by the welding arc.

The welding arc produces intensive UV and IR irradiation capable of inflicting burns of the cornea of a welder's eyes or his facial skin. Since UV and IR irradiation are not visible and thus not necessary for lighting the welding area, an embodiment of the protective glass or shutter wherein both parts of the spectrum are blocked is preferable.

Resistance to dust, sparks, electromagnetic pulses, and temperature variations are also desirable characteristics.

Many types of LC devices are known which are capable of operating as electrically-driven optical filters or shutters. The most common and generally most effective LC devices for this function are based on liquid crystals in the nematic phase, operating with the use of the twist effect, that is, a twist of the polarization plane of the light passing through a layer of liquid crystal material. Such optical devices and principles of their operation are well known and described in the literature, e.g., S.-T. Wu, D.-K. Yang, “Reflective Liquid Crystal Displays” 2001, by John Willey and Sons Ltd.

The principle of operation of a twisted-nematic liquid crystal cell is based on the use of a pair of polarizers employed together with a voltage-driven LC cell. A front polarizer polarizes the incident light, whereafter its polarization plane is twisted through a certain angle, as light passes through the liquid crystal layer, whereafter light meets a second polarizer. The second polarizer is also called as an analyzer. A change in the voltage across the liquid crystal results in a change in a twist angle of the polarization plane, as light passes through the liquid crystal layer. This allows the light intensity to be controlled at the exit from the display by changing an angle between the light polarization plane at the exit from the liquid crystal and the transmission axis of the analyzer.

The liquid crystal cell described above contains a plurality of layers including at least a liquid crystal layer, polarizer(s) and analyzer layers, alignment layers for inducing orientation of the liquid crystal layer, electrodes and substrates. Depending on the particular technical application, the plurality of layers can also include a reflective layer, retarders, planarization layers, insulating layers, adhesive layers, antireflective and antiblazing coatings, light-scattering layers, etc.

Usually the term liquid crystal cell denotes the plurality of layers including the liquid crystal layer, supporting glass or plastic substrates, alignment layers and electrodes. The polarizers (analyzers) are typically placed on the external sides of the substrates and are therefore not usually included as part of the LC cell. In this case, the polarizers (or analyzers) are called external polarizers. Sometimes it is possible to insert the polarizers (analyzers) inside the LC cell, and polarizers of this kind are named internal polarizers. Herein we refer to the liquid crystal cell in the usual sense, that is as not containing polarizers (analyzers).

The main parameters of a liquid crystal cell, which determine its operating characteristics, are the twist angle of directors of LC molecules, the thickness of the liquid crystal layer, and the refractive indices of ordinary and extraordinary directions in the LC materials. The twist angle of directors of molecules is determined by the alignment of surface layers of the liquid crystal and by chiral dopants which are introduced into the composition of the liquid crystal. The aligning of directors of LC molecules in boundary layers of the liquid crystal is determined by aligning layers, that is, by thin polymeric layers where an oriented surface microstructure is created. The direction of this microstructure is often called the rubbing axis.

In order to provide an LC shutter with high contrast, high transmission, neutral color rendering, and small switching time, etc., it is necessary to decrease the thickness of the LC layer. When the LC layer parameters do not satisfy the waveguide condition (the Mauguin Condition):

$$( {n}_{e} - {n}_{o} ) d >> \frac{φ λ}{π} \qquad ( 4 )$$

the linearly polarized light at the exit from the liquid crystal becomes elliptically polarized. Here nₒ and nₑ are the refractive indices of ordinary and extraordinary rays in a liquid crystal, respectively, d is the crystal thickness, λ is a wavelength of the visible light (400-700 nm), and φ is the total twist angle.

In this case, the result is a decrease in the darkening degree of the dark state and/or a decrease in the transparency of the light state. One way to overcome this effect is through selection of the operating mode of the liquid crystal. The work in this field was mainly carried out with LC displays as examples, but it is equally applicable to problems concerning liquid crystal shutters.

The operating mode of a generalized liquid crystal optical device is controlled by mutual orientation of axes of each polarizer and the director of LC molecules in a layer adjacent to each polarizer, or by birefringence of a liquid crystal, or by a selected twist angle of directors of molecules in the bulk of a liquid crystal when passing from one side of a liquid crystal layer to the other one.

Moreover, for a selected operating mode of a liquid crystal device, the presence of optical phase retarders is of importance, as well as their characteristics.

The description of operating modes of liquid crystals and calculation methods can be found in: H S Kwok and J Chen, Generalized Parameter Space Diagrams For All Liquid Crystal Displays, pp 165-169, ASID 1999, H. S. Kwok, Parameter Space Representation Of Liquid Crystal Display Operating Modes, J. Appl. Phys., Vol. 80, No. 7, pp 3687-3693, October 1996, H. Cheng, H. Gao, and F. Zhou, Dynamic Parameter Space Method To Represent The Operation Modes Of Liquid Crystal Displays, Journal of Applied Physics, 86, p.5935, 1999, and many other publications.

To describe the operation of a display shutter when used to protect a welder's eyes, one often concentrates on two sides with respect to a light source (electric arc or other sources) and the welder's eyes. A LC shutter is always disposed between an irradiation source and a welder's eyes. Therefore, it is convenient to identify the side of the shutter which faces a light source as the front one, and the side facing a welder as the rear one. This difference between the sides of the shutter appears only upon its direct employment because all known LC shutters are capable of operating with either side facing a light source. The set of layers of an LC cell, disposed before and after the liquid crystal, is often called the front panel and the rear panel, respectively. Similar operating layers, disposed in different panels, are identified as front and rear ones, for example, rear and front substrates, rear and front electrodes, etc.

Two of the most important parameters that determine the efficiency of a shutter are the time of switching a shutter from the light state to the dark state and the contrast ratio value (the darkening degree). The shutter, which is suitable for use in practice, should have a contrast ratio of no less than about 300 (i.e., a darkening degree of no less than 10 in the dark state and no greater than about 4 in the light state) and a switching time of no greater than 0.1 second, preferably, less than 0.02 second. The use of a shutter with a single liquid crystal cell impedes the fulfilment of these conditions. In this case, to ensure a high contrast ratio and an acceptable darkening degree, one needs a large thickness of a liquid crystal. On the other hand, the switching time of a liquid crystal layer increases in direct proportion to the square of its thickness.

A solution to this technological problem is the use of a pair of LC shutters disposed sequentially along the light path, driven in a synchronous way by one voltage source, and separated by one or two polarizers. The additional polarizer(s) enable a sharp increase in the contrast ratio (the darkening degree) due to the enhanced dichroism within the dual-shutter device as well as suppression of depolarizing action of the liquid crystal and other operable layers of the display caused by light scattering inhomogeneities. At the same time, a decrease in the thickness of the liquid crystal layers in each of the two shutters decreases the LC switching time of the composite shutter stack.

Therefore, a double shutter stack allows one to use liquid crystal layers with a small thickness and a small switching time and simultaneously to substantially increase the contrast ratio and darkening degree of an LC shutter as a whole.

Upon an oblique incidence of a light beam onto a twist-nematic liquid crystal, the birefringence becomes a complicated function of a large set of parameters, namely, the azimuthal angle (θ) between the incident angle and the normal to the surface of the liquid crystal and the polar angle (φ), the distribution of twist angles of directors of LC molecules along the light path, and the refractive indices of the ordinary and extraordinary rays.

If one considers a liquid-crystal cell, in which directors of all molecules are aligned in one direction and the angle between these directors and the direction of light propagation is ψ, then the effective birefringence may be described by the formula:

$${( d Δ n )}_{eff} = \frac{d}{cos θ} [ \frac{{n}_{e} {n}_{o}}{{[ {n}_{e}^{2} {cos}^{2} ( ψ ) + {n}_{o}^{2} {sin}^{2} ( ψ ) ]}^{1 / 2}} - {n}_{o} ] \qquad ( 5 )$$

Here, the following designations are adopted: d is the crystal thickness, nₒ and nₑ are the refractive indices for the ordinary and extraordinary rays respectively, and θ is the angle between the light beam direction and the normal to the crystal layer.

Such a complicated dependence on the angles leads to elliptical light polarization at the exit from the crystal for oblique incident angles, which, in turn, causes a “leakage” of light through a dark shutter at oblique angles and decreases the contrast ratio and the darkening degree. In practice, this effect is expressed in a restricted viewing angle within which a high contrast ratio may be obtained, as well as in an asymmetrical viewing volume.

One commonplace and cost-effective method of combating the angle restrictions includes using various optical phase retarders. See S.-T. Wu, D.-K. Yang, “Reflective Liquid Crystal Displays” 2001, by John Willey and Sons Ltd. The retarders are inserted in the optical path between the input and output polarizers (analyzers) and the liquid crystal layer. A value of the phase delay produced by the retarders should compensate the difference in phase shifts existing between the oblique and normal angles. It is evident that the simplest way to attain this condition is to use the retarder with a negative birefringence:

nₑ−nₒ=Δn<0 (6)

If parameters of the retarder are chosen correctly, then the sum of birefringences, after ordinary and extraordinary rays pass through the liquid crystal and the retarder, either should be equal to zero or can be made sufficiently small. The disadvantage of such a solution is that the compensation is achieved selectively for individual wavelengths (i.e., the dispersion properties are exhibited). This results in a distorted color rendering upon viewing at oblique angles and in a colored transmittance of gray levels.

In liquid crystal displays, it is possible to use discotic liquid crystals with the twist effect. See H. Mori, P. J. Bos,. Optical Performance of the π Cell Compensated with a Negative-Birefringence Film and an A-plate, Japanese Journal of Applied Physics, Vol. 38, 1999, pp. 2837-2844; M. Lu, H. Yang, Low Voltage and Wide-Viewing Angle Twisted Nematic Liquid Crystal Displays, by Optical Commensuration, Japanese Journal of Applied Physics, Vol. 39, 2000, pp. L412-L415. In this case, compensation of the anisotropy at oblique angles is achieved by a compensatory discotic liquid crystal with constant twist angle and the nematic liquid crystal with the electrically controlled twist angle having the same or similar optical characteristics, but twist angles of directors in these liquid crystal layers are opposite to each other. A disadvantage of this solution, for use in an LC shutter, is a low darkening degree provided by the method. Another drawback is the complication of the shutter design and due to the use of the additional compensating films with original liquid crystal layer structure.

U.S. Pat. No. 4,039,254 describes an autodarkening glass used in welding wherein two liquid crystal cells and three polarizers are employed in a series: polarizer—LC cell—polarizer—LC cell—polarizer with parallel axes of all the polarizers. A combination of two cells allows a high darkening degree needed in welding. A disadvantage of this device is a small viewing angle.

U.S. Pat. No. 4,240,709 describes a liquid crystal display shutter (an autodarkening glass) wherein a pair of LC cells with a liquid crystal having a thickness of less than 8 μm are used and polarizers and directors of molecules in LC cells are aligned in a specified manner with respect to each other. One disadvantage is the considerable asymmetry of the viewing angle and the complicated fabrication technology.

U.S. Pat. No. 5,515,186 describes a liquid crystal shutter wherein the rear polarizer of the front cell and the front polarizer of the rear cell are disposed in such a way that their transmission axes are not parallel. This increases the darkening degree of the shutter. One disadvantage of this device is the complication of fabrication technology and the decrease in transparency in the light state.

A liquid crystal display shutter is proposed wherein the improvement of angle characteristics is achieved due to a decrease in the twist angle of directors in the liquid crystal cell. See EP706674, WO9529428, U.S. Pat. No. 5,825,441. One disadvantage is the asymmetry of the viewing angle and the small transparency of the shutter in the light state.

U.S. Pat. No. 6,097,451 describes a liquid crystal shutter wherein due to using liquid crystals with a twist angle of directors from less than 20° to 80°, driven by constant or alternating voltage of low frequency (less than 1 Hz), a possibility to control transparency of the liquid crystal cell is achieved. As disadvantages of this device, an asymmetrical and small viewing angle should be noted.

U. S. patent application Publication No. 20010017681 describes a liquid crystal shutter wherein to improve the operating characteristics of the cell, a retarder whose fast axis does not coincide with the fast axis of the liquid crystal, is introduced into a layer composition. One disadvantage of this device is the relatively complicated technology of fabrication, caused by the presence of additional layers and the necessity of their mutual orientation.

### SUMMARY OF THE INVENTION

The present invention is aimed at elimination of disadvantages of the known liquid crystal shutters, namely a low contrast ratio at large viewing angles, an asymmetrical dependence of the contrast ratio on the viewing angle, a large switching time, and large driving voltages.

The liquid crystal shutter of the invention comprises at least two liquid crystal cells and at least three polarizers. Each of the liquid crystal cells contains a plurality of layers between two substrates and is disposed between two adjacent polarizers. The adjacent two liquid crystal cells have substantially equal absolute values and opposite directions of twist angles. The liquid crystal shutter of the invention substantially increases the viewing angle and the contrast ratio at large viewing angles, provides a symmetrical dependence of the contrast ratio on the viewing angle, and decreases the switching time as well as the driving voltages.

### BRIEF DESCRIPTION OF THE DRAWINGS

The present invention will be more clearly understood upon reading the following detail description and the accompanying drawings in which:

FIG. 1 is an exploded view of an LCD shutter showing layers.

FIG. 2 is an exploded view of an LCD shutter having an intermediate polarizer (201) in accordance with one embodiment of the present invention.

FIG. 3 is an exploded view of an LCD shutter having an internal polarizer (301) in one of rear cells in accordance with one embodiment of the present invention.

FIG. 4 is an exploded view of an LCD shutter wherein all polarizers (401, 402, 403, 404) are internal in accordance with one embodiment of the present invention.

FIG. 5 is an exploded view of an LCD shutter with a common panel of the front and rear cells in accordance with one embodiment of the present invention.

FIG. 6 is an exploded view of an LCD shutter having an ultraviolet (601) and infrared (602) filter in accordance with one embodiment of the present invention.

FIG. 7 illustrates the directions of axes of polarizers, rubbing axes of the liquid crystal, and the twist of directors of LC molecules for the front cell.

FIG. 8 illustrates the directions of axes of polarizers, rubbing axes of the liquid crystal, and the twist of directors of LC molecules for the rear cell.

FIG. 9 shows an angular dependence of the contrast ratio for the LCD shutter in accordance with one embodiment of the present invention.

FIG. 10 shows a transmission spectrum for the LCD shutter in accordance with one embodiment of the present invention.

### DETAILED DESCRIPTION OF THE INVENTION

The present invention provides an LCD shutter having a substantially increased viewing angle, good contrast ratio at large viewing angles, symmetrical dependence of the contrast ratio on the viewing angle, short switching time, and decreased driving voltage.

The technical result of the invention is achieved by an LCD shutter comprising at least two liquid crystal cells and at least three polarizers. Each of the liquid crystal cells contains a plurality of layers between two substrates and is disposed between two adjacent polarizers. The adjacent two liquid crystal cells have substantially equal absolute values and opposite directions of twist angles. In each of the cells, the transmission axes of the polarizers are parallel to directors of the LC molecules in the layer nearest to the polarizer. Upon disposition of cells one after another, the transmission axes of adjacent polarizers of different cells are parallel.

The effect of compensation of asymmetry of the viewing angle is achieved due to different directions of twist angles of LC molecules while retaining the electro-optical characteristics in the different cells. It is assumed that, in both liquid crystal layers, the twist of molecules in the bulk of the crystal occurs uniformly so that the value of the twist angle rises linearly with a distance from the boundary of the crystal layer. The latter circumstance is a typical and standard property assumed in the physics of liquid crystals. See L. M. Blinov, Electro-Optical and Magneto-Optical Properties of Liquid Crystals, J. Wiley, Chichester, 1983.

Different directions of twist angles in liquid crystal layers of the cells can be provided by the appropriately oriented rubbing directions in each cell along with the commensurate doping of the liquid crystal material of the cell with various chiral dopants of appropriate twist sense and concentration.

In one embodiment, an intermediate polarizer is used which replaces the rear polarizer of the front cell and the front polarizer of the rear cell. This polarizer is disposed between the transparent rear substrate of the front cell and the transparent front substrate of the rear cell. This design allows simplification of the cell construction and reduction of cost due to using one polarizer instead of two.

In another embodiment, at least one polarizer of the shutter is internal. In this case, the resistance of the shutter toward scratches and other mechanical damages increases in both assembling and operation. The decrease of the thickness of layers raises the darkening degree and transparency of the cell at oblique and normal viewing angles thus improves color rendering and achromatism of the cell. The best results, as well as simplicity of fabrication of the cell, are achieved when all polarizers of the shutter are internal.

In another embodiment, the rear panel of the front cell and the front panel of the rear cell are combined in one intermediate panel due to removal of the transparent substrate between them and the use of at least one intermediate polarizer. In this case, the layer thickness decreases, the darkening degree and cell transparency at oblique and normal angles increase, and color rendering and achromatism are improved. This simplifies the shutter and enhances its reliability.

In a further embodiment, the shutter is constructed of a pair of identical liquid crystal cells. Both cells have the same sequence of layers and the same mutual orientation of anisotropic layers (liquid crystal, polarizers, aligning layers, and retarders). In this case, identical functional layers of each cell are made of the same materials and have the same operating parameters. The only difference between the cells is a direction of twist angles: the directions are opposite to each other in different cells. This simplifies fabrication of the cell and reduces the cost of the shutter.

In constructing the shutter from a pair of liquid crystal cells with connected transparent substrates, interference effects may arise. To eliminate them, the cells may be connected by means of a material whose refractive index is equal to that of the material of transparent substrates in such a way that there is no air gap between the rear panel of the front cell and the front panel of the rear cell.

In one embodiment, the darkening degree is increased when the transmission axis of the rear polarizer of the front cell and that of the front polarizer of the rear cell compose an angle greater that 0° and smaller than 90°.

In another embodiment, the twist angle of directors of LC molecules, when passing from one side of the liquid crystal to the other, is equal to 90° in both cells. This simplifies the technology of fabrication of the shutter due to the use of a liquid crystal with a traditional twist angle of directors and increases transparency of the cell in the light state.

In a further embodiment, the twist angle of directors of LC molecules, when passing from one side of the liquid crystal to the other, amounts from 20° to 85° (absolute values) in both cells. This improves the angular characteristics of the shutter and decreases the time of switching from the dark state to the light state. The latter circumstance is of great importance for improvement of eye protection.

In one embodiment, the darkening degree of the cell, and the transparency and angular characteristics are improved with at least one retarder included in the shutter.

In another embodiment, the liquid crystal thickness is selected in such a way that switching from the dark state to the light state occurs for a time shorter than 0.02 second. This ensures a reliable protection of a welder's eyes.

In a further embodiment, light filters may be included into the composition of layers to decrease the intensity of UV and IR irradiation by no less than 10 DIN units. The presence of UV and IR filters allows protecting eyes and facial skin against irradiation in UV and IR regions. A necessity to use UV and IR light filters arises because of weak attenuation efficiency of the shutter in these spectral regions. Light filters may be set in an arbitrary place, between any adjacent layers, when this does not disturb operability of the shutter as a whole. The function of a UV and/or IR light filter may be performed by a polarizer or another operating layer of the shutter due to introducing substances, transparent in the visible region and non-transparent in UV and IR regions, into a composition of its material.

In another embodiment, at least one of the internal polarizers of the shutter is disposed between a transparent substrate and an electrode of one panel of the display. In this case, because of disposition of a polarizer having a high dielectric constant (∈>15) in the space between the liquid crystal electrodes, the switching voltage decreases. This is due to a decrease in capacity of an inter-electrode capacitor. Using an internal polarizer, the total layer thickness decreases, the viewing angle with a high value of the darkening degree in the dark state increases, and transparency of the shutter in the light state also increases.

In a further embodiment, at least one of the internal polarizers additionally fulfils a function of an alignment layer, a correcting light filter layer, or a UV and/or IR filter layer, or the combined functions of at least two said layers. In this embodiment, due to simplification of the construction, a greater reliability of the shutter is achieved. This is due to a decrease in the number of layers, the thickness decreases, the viewing angle of the shutter with a high value of the darkening degree in the dark state increases, and transparency of the shutter in the light state also increases.

In another embodiment, an additional scattering layer is introduced into the composition of operable layers which suppresses interference effects in the layers of the LC shutter. This allows an increase in transparency and the darkening degree of the LC shutter and improves its angular characteristics. In another embodiment of the LC shutter, a light scattering function is given to one of the operable layers of the cell by introducing into the composition additional microparticles capable of scattering light.

In the absence of a voltage across the electrodes of liquid crystals, the shutter is in the dark state and the darkening degree is greater than 9 DIN units. Eye protection is ensured if the power feeding of the LC shutter fails.

In another embodiment of the LC shutter, the switching from the light state to the dark state or from the dark state to the light state is carried out automatically in response to a signal from a photosensitive element located within direct visibility with respect to an irradiation source.

In another embodiment, as an internal or external polarizer, a thin film crystal TCF polarizer fabricated by Optiva Inc. of South Francisco, Calif. is used. See for instance, Y. Bobrov et al., Thin Film Polarizers for Liquid Crystal Displays, Proceedings of SPIE, vol. 4511, 2001, pp. 133-140. The technical result of the invention allows elimination of asymmetry of the viewing angle of the LC shutter to be realized. In such cases, when restrictions on the viewing angle associated with anisotropy of the liquid crystal are removed, the actual restrictions prove to be frequently related to polarizers, more precisely, to light transmission through crossed polarizers at oblique angles. Thin crystal film polarizers, as compared to traditional ones, are a good means to solve this problem due to a small thickness and high dichroism upon viewing at oblique angles. Good polarizing properties of these films at oblique angles allows increasing the viewing angle with a high darkening degree.

The properties of thin-film polarizers fabricated by Optiva Inc. are as follows: thermal stability and resistance toward temperature variations; a small thickness; high anisotropy of refractive indices; anisotropy of absorbancies; high polarizing properties at oblique angles; a high value of dichroic ratio; and simplicity of fabrication.

These properties allow improvement of angular characteristics of the shutter, increase of transparency and the darkening degree, decrease of the total layer thickness, simplification of the technology of manufacturing the shutter, and saving of the cost.

Original properties of these polarizers are caused by specific features of the material used and by a method of forming the crystalline film, namely, by molecular-crystalline structure of the film material, which is formed by crystallization of the liquid phase of at least one organic substance producing a lyotropic liquid crystal phase. Crystallization is carried out by coating some substrate with a liquid crystal with application of aligning action and subsequent drying. As an organic substance, at least one organic compound is used whose formula contains at least one ionogenic group, providing solubility in polar solvents, and/or at least one nonionogenic group, providing solubility in nonpolar solvents, and/or at least one counterion that either remain in the structure of the molecule during preparation of the material or do not remain therein.

An optically anisotropic dichroic crystalline film is formed by a set of supramolecular complexes of one or several organic compounds. See Jean-Marie Lehn, Supramolecular Chemistry, Concepts and Perspectives, Weinheim; N.Y.; Basel; Cambridge; Tokyo, VCH Verlagsgesellschaft mbH, 1995. In this case, supramolecular complexes are aligned in a definite way to provide polarization of transmitting light.

Initial choice of the material for formation of optically anisotropic dichroic crystalline film is determined by the presence of a system of π-conjugated bonds in aromatic conjugated cycles and by the presence in molecules of fragments of the type of amino, phenolic, ketonic, etc. groups, lying within the plane of a molecule and belonging to the aromatic system of bonds. The molecules themselves or their fragments have planar structure. For instance, these may be such organic compounds as indanthrone (Vat Blue 4), or a dibenzimidazole derivative of 1,4,5,8-perylenetetracarboxylic acid (Vat Red 4), or a dibenzimidazole derivative of 3,4,9,10-perylenetetracarboxylic acid, or quinacridone (Pigment Violet 19), etc., whose derivatives or mixtures thereof form a stable lyotropic phase. Then, this choice may be corrected by requirements for a transmission spectrum in the visible light region. The use of dyes, as initial materials, makes it possible to employ polarizers as correcting color or neutral light filters, as well as UV or IR filters. A choice between these opportunities is determined by a technical problem to be solved, employed materials, etc.

On dissolving such an organic compound in a suitable solvent, a colloid system is formed (a lyotropic liquid crystal), in which molecules are associated in supramolecular complexes being kinetical units of the system (WO0163346). A liquid crystalline phase is a pre-ordered state of the system which determines initial anisotropy of the material. In a process of alignment of supramolecules and a subsequent removal of the solvent, a solid crystalline film, possessing optical anisotropy, in particular, dichroism, is formed.

A process of aligning a polarizer leads to formation at its surface of a structure consisting of micro-irregularities. This structure has a predominant direction. This allows using polarizers as aligning layers.

In the obtained optically anisotropic dichroic crystalline film, planes of molecules are parallel to one another and the molecules form a three-dimensional crystal, at least in a part of a crystalline film. In optimization of a fabrication method, it is possible to obtain a monocrystalline optically anisotropic dichroic film. The optical axis in such a film will be perpendicular to the plane of molecules. Such a crystalline film will possess a high degree of anisotropy and, at least for one direction, a high refractive index and/or high absorbance, that is, it will have polarizing properties.

It is possible to provide a necessary anisotropy of absorbances and refractive indices, as well as alignment of main axes, that is, optical properties of an anisotropic dichroic crystalline film in the multilayer structure, by presetting a definite angular distribution of molecules in the polarizing film at the surface of a substrate.

It is also possible to mix colloid systems (in this case, mixed supramolecules is formed in a solution) to obtain crystalline films with intermediate optical characteristics. In optically anisotropic dichroic crystalline films obtained from mixtures of colloid solutions, absorption and refraction may be characterized by different values in ranges determined by initial components. Mixing different colloid systems with formation of mixed supramolecules is possible due to a coincidence of one of molecular dimensions (interplanar distances) of different organic compounds (3.4 ±0.3 Å).

A possibility to affect optical properties of a film in a process of its fabrication by all said methods allows fitting them to specificity of a concrete problem. Thus, it allows varying the absorption spectrum of a polarizer that is useful for providing a correct color rendering and achromatism of a display or shutter. Due to the use of birefringence of films, they can be employed as retarders with a preset phase shift for a given wavelength. Variation of optical anisotropy allows improving angular characteristics of devices with thin film crystalline polarizers.

The thickness of optically dichroic crystalline film is controlled by the content of a solid in a coating solution. The concentration of a solution, which can be conveniently controlled in fabrication, serves as a technological parameter in formation of such optically anisotropic dichroic crystalline films.

Surfaces, at which crystalline films are deposited, may be subjected to additional treatment to provide uniform wettability (to provide hydrophilic properties of the surface). This may be mechanical treatment, annealing, and mechanochemical treatment. Similar treatment can also facilitate decreasing the thickness of a film and increasing the ordering degree. Furthermore, to enhance the ordering in the film at the surface of a substrate, aligning anisotropic structures may be formed by mechanical treatment of the surface of a substrate.

Optical dichroism of the film allows using polarizers fabricated therefrom as retarders to increase the contrast ratio or angular characteristics of the display.

The use of the thin crystal film fabricated by Optiva Inc. allows an increase in the viewing angle of the shutter, an increase in the darkening degree in the dark state and transparency in the light state, a smaller display thickness, simplification and reduction of fabrication costs, and broadening the temperature range of employment of the display.

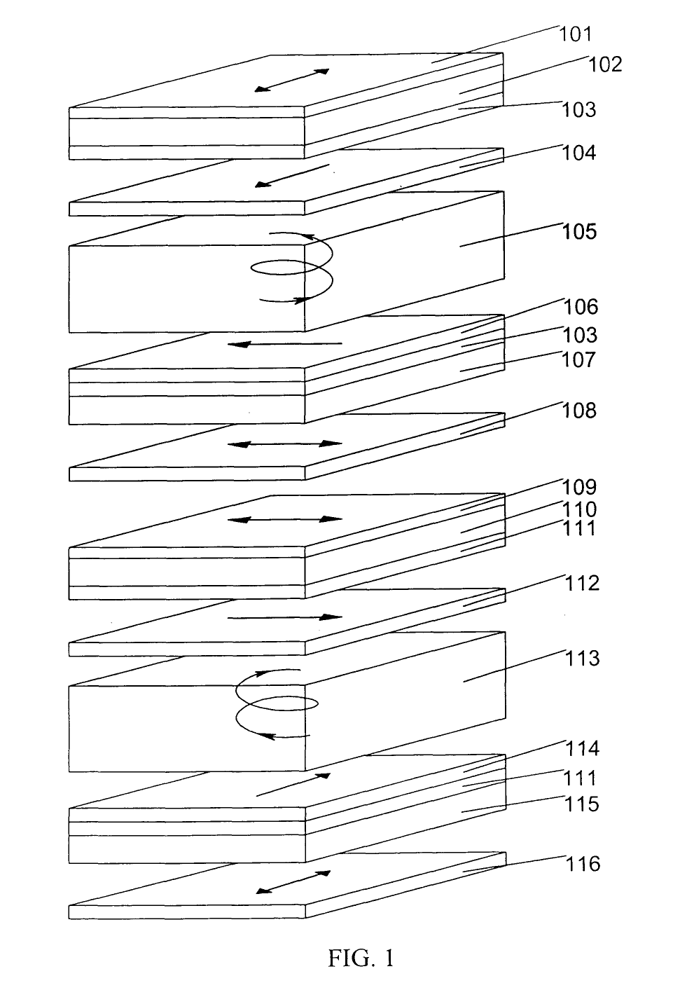

Various illustrative embodiments are described with reference to the drawings. In the embodiment of FIG. 1, the LCD shutter comprises a front and rear LC cells. The front LC cell comprises a front polarizer (101), a transparent substrate (102), a transparent electrode (ITO, 103), a front aligning layer (104), a liquid crystal (105), a rear aligning layer (106), a transparent rear substrate (107), and a rear polarizer (108). The rear LC cell comprises a front polarizer (109), a transparent substrate (110), a transparent electrode (ITO, 111), a front aligning layer (112), a liquid crystal (113), a rear aligning layer (114), a transparent electrode (ITO, 111), a transparent rear substrate (115), and a rear polarizer (116). Arrows on aligning layers (104, 106, 112, 114) designate the rubbing directions coinciding with directors of LC molecules in a nearest layer of a liquid crystal. Arrows on polarizers (101, 108, 109, 116) designate directions of transmission axes of polarizers. Helices, with arrows, inside liquid crystals, designate the twist of directors of molecules of a liquid crystal. In different crystals, the twist directions are opposite to one another and the twist angles, when passing from one side of a crystal to the other one, are equal in value.

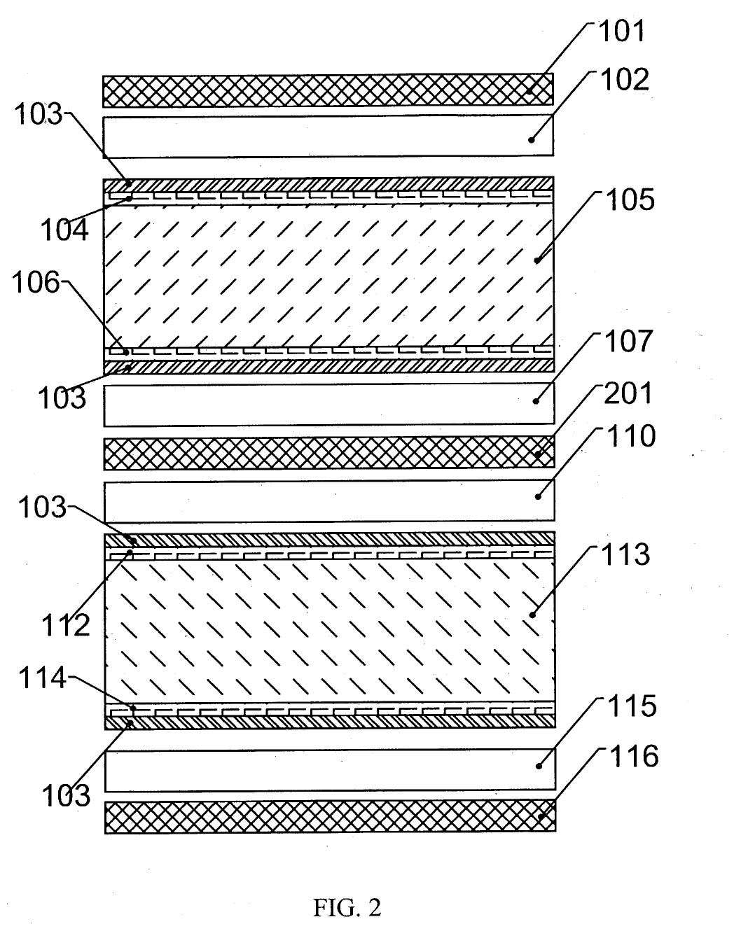

FIG. 2 illustrates an embodiment of the shutter with an intermediate polarizer (201). Here, a front LC cell has only a front-polarizer (101), a rear cell has only a rear polarizer (116). Instead of the rear polarizer of the front cell and the front polarizer of the rear cell, an intermediate polarizer (201) is set between transparent substrates (107, 110).

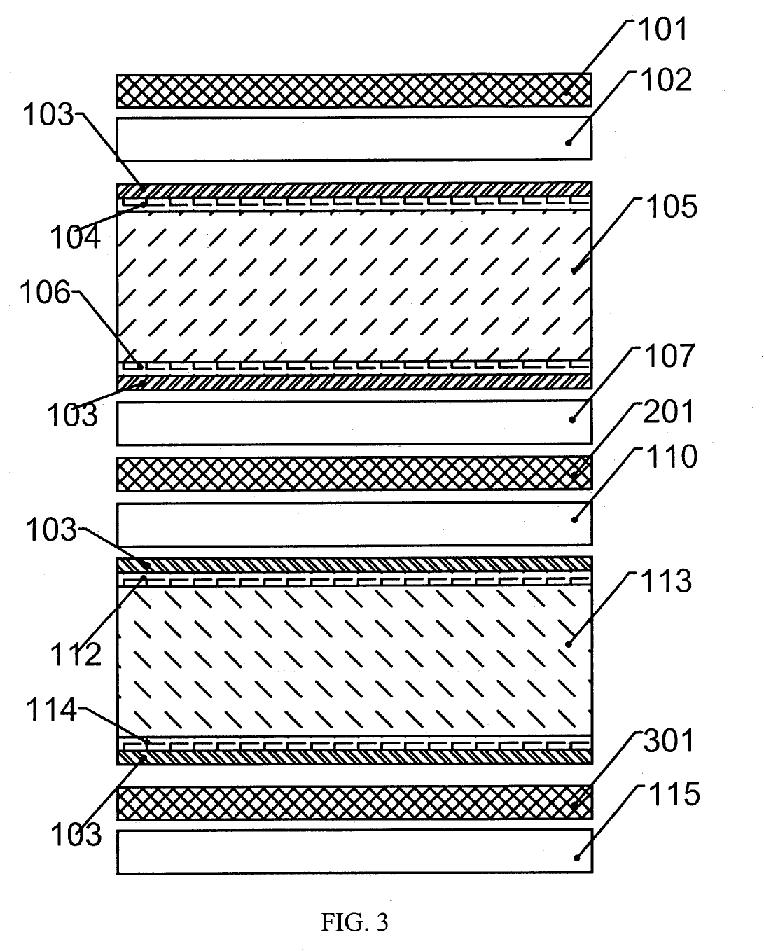

FIG. 3 illustrates an embodiment of the shutter with an internal polarizer (301) in one of the cells. In this embodiment, the rear polarizer (301) in the rear cell is disposed between an electrode (103) and transparent substrate (115) and operates as internal.

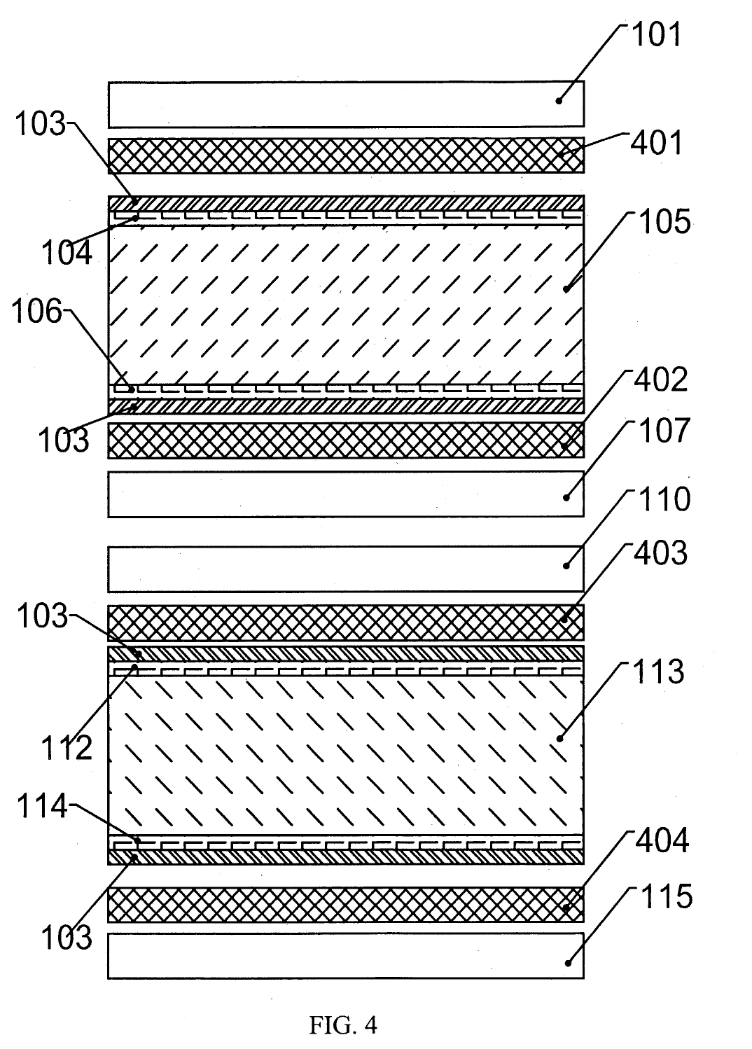

FIG. 4 illustrates an embodiment of the shutter wherein all polarizers (401, 402, 403, 404) are internal. In this embodiment, each of the polarizers is disposed between a transparent substrate (101, 107, 110, 115, respectively) and an electrode (103).

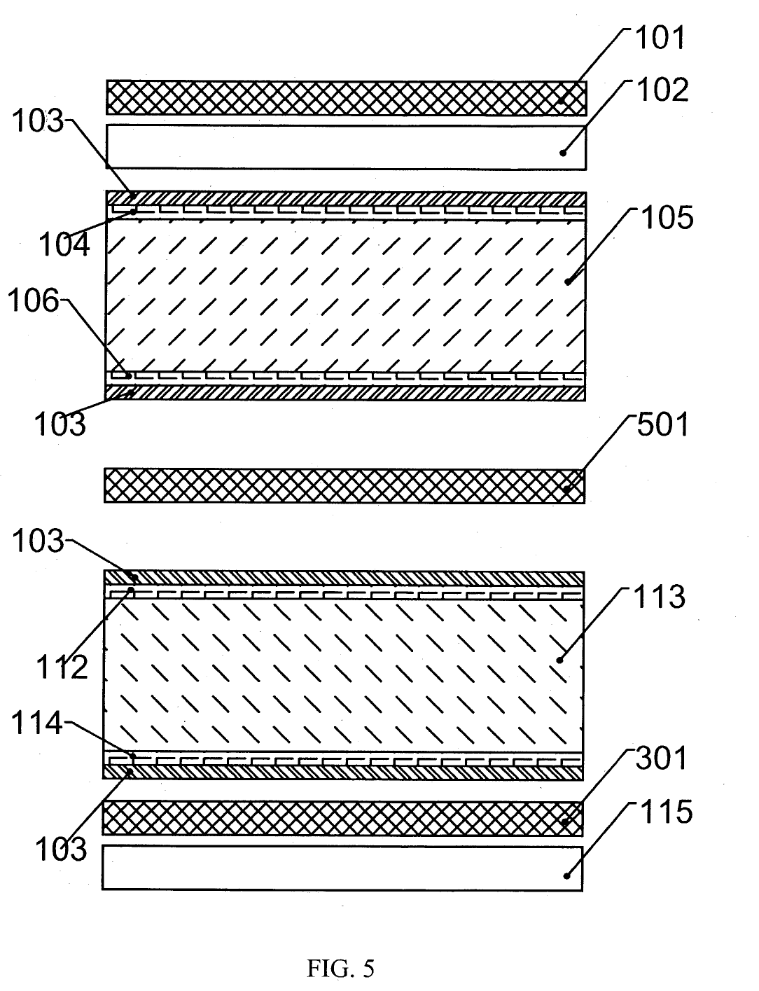

FIG. 5 illustrates an embodiment of the shutter with a common panel of the front and rear cells. In this embodiment, after a liquid crystal (105) of the front cell, a rear aligning layer (106) and a transparent electrode (103) of the front cell are disposed. After the electrode, an intermediate polarizer (501) is disposed, immediately after which a transparent electrode of the front cell (103) is set, then a front aligning layer (112) of the rear cell and a liquid crystal (113) of the rear cell are disposed.

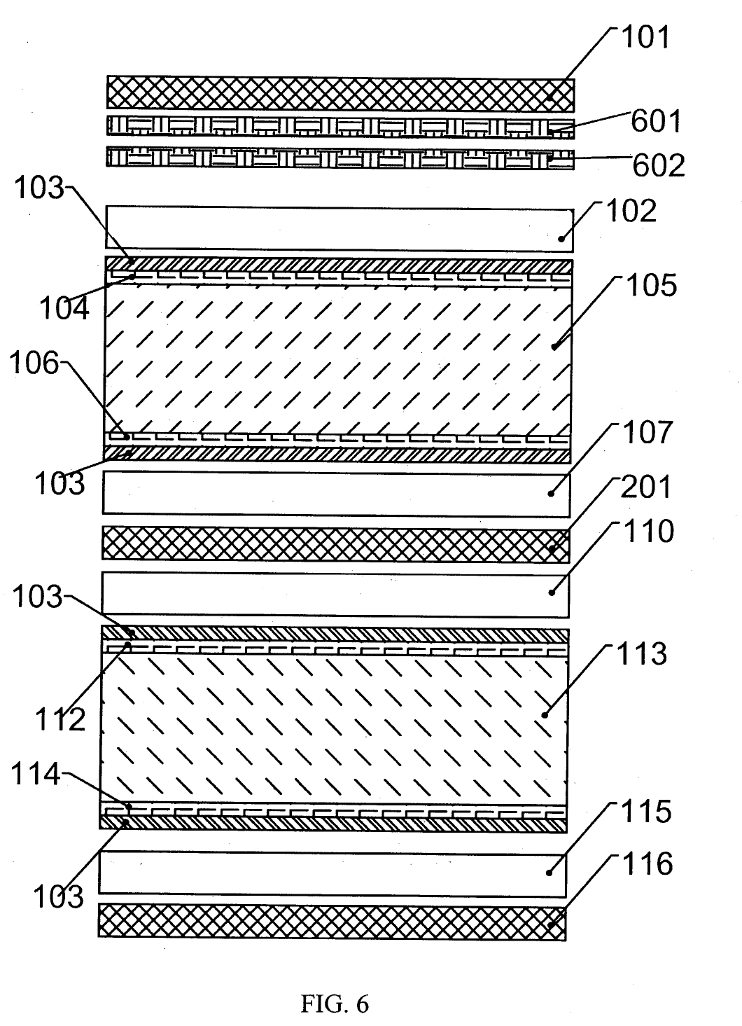

FIG. 6 illustrates an embodiment of the shutter with an ultraviolet (601) and infrared (602) filters. In this embodiment, an ultraviolet filter (601), which suppresses irradiation in the ultraviolet region, and an infrared filter, which suppresses irradiation in the infrared region, are disposed one after another along the light path, thereby a pair of filters are disposed between a transparent substrate (102) and a transparent electrode of the front cell.

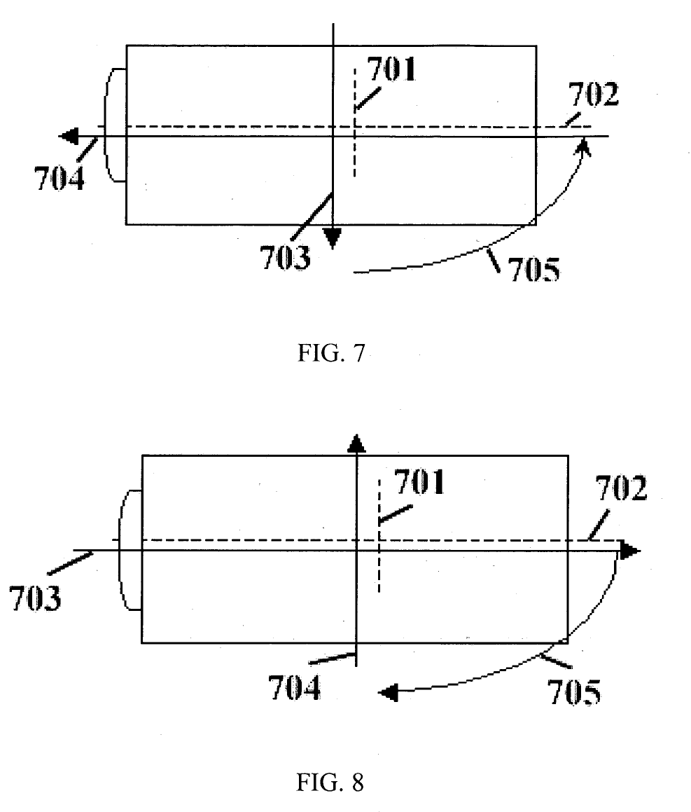

FIG. 7 illustrates an example of the front cell of the invention showing the direction of the transmission axis of a front (701) and rear (702) polarizers, the rubbing directions of a front (703) and rear (704) aligning layers, and the twist of directors of LC molecules (705).

FIG. 8 illustrates an example of the rear cell of the invention showing the direction of the transmission axis of a front (701) and rear (702) polarizers, the rubbing directions of a front (703) and rear (704) aligning layers, and the twist of directors of LC molecules (705).

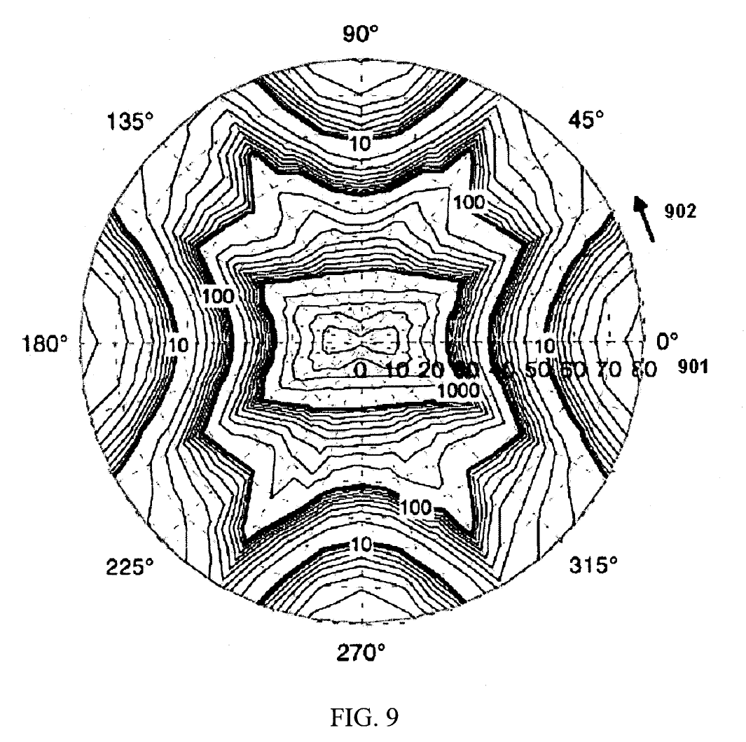

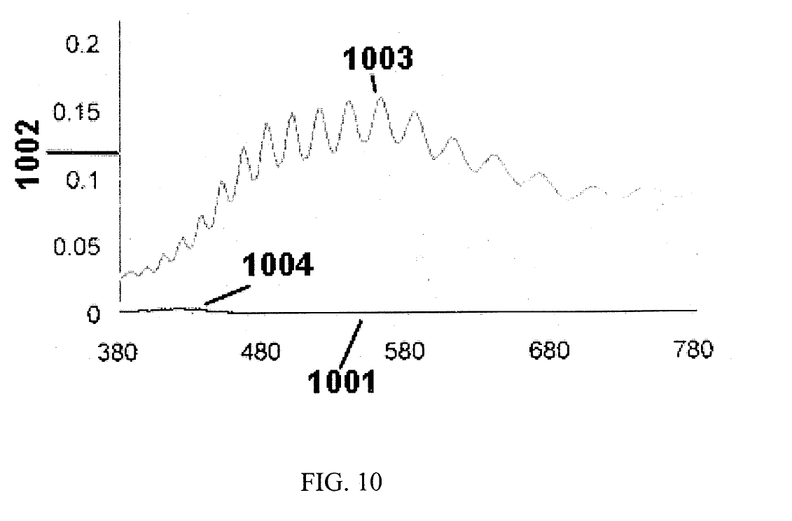

FIG. 9 shows the angular dependence of the contrast ratio for the LC shutter taken from an embodiment of the invention. The Figure shows curves of the constant contrast ratio with a logarithmic step of 1 plotted in polar coordinates as a function of azimuthal (901) and polar (902) angles FIG. 10 shows a transmission spectrum for an LCD shutter taken from an embodiment of the invention. In FIG. 10, Reference number 1001 represents wavelength axis, reference number 1002 represents transmission axis in fractions of unity: Reference number 1003 represents the transmission spectrum for the switched-on state and 1004 represents the transmission spectrum for the switched-off state.

### EXAMPLE

The LCD shutter included two sequential combined cells (front and rear ones).

The rear cell was comprised of (from the front cell to the rear one) a front transparent protective substrate, a front transparent electrode, an insulating layer to protect the cell against electrical breakdown, a front polarizer made of an Optiva thin crystalline film, an aligning layer, liquid crystal, an aligning layer, a rear polarizer made of an Optiva thin crystalline film, an insulating layer to protect the cell against electrical breakdown, a transparent rear electrode, and a rear transparent protective substrate.

The construction of the front cell precisely was the same as the construction of the rear cell except for their liquid crystals. The liquid crystals of the front and rear cells had opposite twist angles to provide a large and symmetrical viewing angle of the shutter. In the front and rear cells, an angle between a front and rear polarizers was 90°, axes of both polarizers were parallel to directors of molecules in an LC layer nearest to a polarizer. In the front cell, the twist of LC molecules occurred along a left-handed helix, in the rear cell, along the right-handed helix. The transmission axes of the front polarizer of the rear cell and the rear polarizer of the front cell were parallel to each other.

The liquid crystal used in cells was a mixture of MLC-6849-100 with three degree pre-tilt angle and an operating voltage range of 0-3.4 V. The thickness of both crystals was 4.1 μm.

In the cells, an Optiva N015-700 polarizer was used. The polarizers of N015 series were thin film crystalline polarizers prepared from an aqueous solution of a mixture of organic dyes having a neutral spectrum (Y. Bobrov et al., Thin Film Polarizers for Liquid Crystal Displays, Proceedings of SPIE, vol. 4511, 2001, pp. 133-140). The film polarizers with a thickness of 100-900 nm were prepared by evaporation of the solvent from a film of the solution and by aligning a coating obtained. To be used as internal polarizers, the polarizer films should generally have a thickness no greater than 800 nm.

The N015 polarizer had a neutral absorption spectrum with a transmittance of about 25-35% in the entire visible region (400-700 nm) which made it preferable for use in devices, where good color rendering and achromatism of a resultant image were required. The polarizer was characterized by a high efficiency (greater than 98%) and a high dichroic ratio (21.6).

A study of angular dependencies of the contrast ratio and light leakage for a pair of crossed N015 polarizers (Y. Bobrov et al., Thin Film Polarizers for Liquid Crystal Displays, Proceedings of SPIE, vol. 4511, 2001, pp. 133-140) showed their superiority over usual polarizers.

FIG. 9 shows the angular dependence of the contrast ratio of the proposed shutter. It is evident that such type of angular dependence is substantially caused by light leakage through crossed polarizers of the shutter, since the use of two liquid crystal cells with opposite twist angles, each of 90°, allows compensating asymmetry of the viewing angle. This, together with high angle characteristics of Optiva polarizers, allows achieving a high contrast ratio and a high darkening degree of the shutter in a large angle range. In this case, the use of two almost identical cells allowed simplification of the technology for fabricating of the shutter.

FIG. 10 shows the transmission spectrum of the LC shutter. Good light absorption in the entire visible region in the dark state is evident, and the shutter provides a transmission spectrum in the light state with a maximum in the spectra region of the best sensitivity of the human eye.

TABLE 1
Thickness of the samples

| | | Single | | | Contrast |
|---|---|---|---|---|---|
| Material | Thickness | transmittance | Light state | Dark state | ratio |
| N015.00 | 700-720 nm | 35% | 13% | 0.0024% | 5100 |
| N015.00 | 620-650 nm | 37% | 16% | 0.008% | 2000 |

What is claimed is:

1. A liquid crystal shutter, comprising:
at least two liquid crystal cells; and
at least three polarizers,
wherein each of the liquid crystal cells contains a plurality of layers between two substrates and is disposed between two adjacent polarizers, and wherein adjacent two liquid crystal cells have substantially equal absolute values and opposite directions of twist angles.

2. The liquid crystal shutter of claim 1, wherein said two liquid crystal cells have substantially equal refractive indices of ordinary directions, substantially equal refractive indices of extraordinary directions, and substantially equal thickness of liquid crystals layers.

3. The liquid crystal shutter of claim 1, wherein the single polarizer is disposed between said two adjacent cells and operates as a rear polarizer of one cell and a front polarizer of another cell.

4. The liquid crystal shutter of claim 1, wherein at least one of said polarizers is internal.

5. The liquid crystal shutter of claim 1, wherein all of said polarizers are internal.

6. The liquid crystal shutter of claim 1 made of two identical liquid crystal cells distinguished only by a twist direction of LC molecules.

7. The liquid crystal shutter of claim 1 wherein said liquid crystal cells are combined without a gap between them by means of an optically transparent material whose refractive index equals a refractive index of transparent substrates.

8. The liquid crystal shutter of claim 1 wherein a front cell has a rear polarizer having a transmission axis, a rear cell has a front polarizer having a transmission axis, and the transmission axes constitute an angle in a range between 0° and 90°.

9. The liquid crystal shutter of claim 1 wherein each of said liquid crystal cells comprises a liquid crystal layer having an absolute twist angle substantially equal to 90°.

10. The liquid crystal shutter of claim 1 wherein directors of liquid crystal molecules are twisted through an angle with absolute values from 20° up to 85° in each of the cells when passing through a liquid crystal layer.

11. The liquid crystal shutter of claim 1 further comprising functional layers of transparent electrodes, transparent protective insulating layers, and transparent aligning layers.

12. The liquid crystal shutter of claim 11, wherein the functional layers include electrodes, and an internal polarizer is disposed between a transparent substrate and an electrode in one of the cell panels.

13. The liquid crystal shutter of claim 1 wherein the substrates are made of glass or transparent plastic.

14. The liquid crystal shutter of claim 4, wherein at least one said internal polarizer is simultaneously a retarder or an aligning layer or a color-correcting light filter or ultraviolet filter or infrared filter or fulfills a function of at least two of said layers.

15. The liquid crystal shutter of claim 1 wherein said plurality layers comprises ultraviolet and/or infrared light filters.

16. The liquid crystal shutter of claim 15 wherein the ultraviolet and/or infrared light filters are disposed in a sequence of layers between an irradiation source and a polarizer, nearest to the latter, of the shutter.

17. The liquid crystal shutter of claim 15 wherein the ultraviolet and/or infrared light filters are disposed in a sequence of layers between an irradiation source and a liquid crystal, nearest to the latter, of the shutter.

18. The liquid crystal shutter of claim 1 further comprising retarders or color-correcting light filters or scattering layers or planarization layers.

19. The liquid crystal shutter of claim 1 wherein the shutter provides a time of switching from a dark state to a light state no greater than 0.02 second.

20. The liquid crystal shutter of claim 1 wherein in the absence of a voltage applied to each of the liquid crystal cells, the shutter is in a dark state and has a darkening degree of no less than 9 DIN units.

21. The liquid crystal shutter of claim 1 wherein the shutter provides a darkening degree no less than 10 DIN units in a dark state and no greater than 4 DIN units in a light state.

22. The liquid crystal shutter of claim 21, wherein the darkening degree in ultraviolet and infrared regions is no less than 10 DIN units in dark and light states.

23. The liquid crystal shutter of claim 1, further comprising a photosensitive element with an electrical circuit, which switches a shutter from a dark state to a light state by a signal from the photosensitive element.

24. The liquid crystal shutter of claim 1, further comprising a photosensitive element with an electrical circuit, which switches a shutter from a light state to a dark state by a signal from the photosensitive element.

25. The liquid crystal shutter of claim 1, wherein an azimuthal viewing angle, corresponding to a darkening degree of no less than 10, equals a value of no less than 60° in any polar direction.

26. The liquid crystal shutter of claim 1 wherein at least one said polarizer is made of an optically anisotropic dichroic film crystal whose substance contains aromatic cycles and is characterized by an interplanar distance of 3.4±0.3Å in a direction of one of the optical axes.

27. The liquid crystal shutter of claim 26 wherein the layer of an optically anisotropic dichroic film crystal is treated with ions of bi- and/or trivalent metals.

28. The liquid crystal shutter of claim 26 wherein the molecules of at least one aromatic organic compound contain heterocycles.

29. The liquid crystal shutter of claim 26 wherein the layer of the optically anisotropic thin crystal film is formed from a lyotropic liquid crystal on the basis of at least one dichroic dye.
